(19) United States
(12) Patent Application Publication
(10) Pub. No.: US 2007/0105596 A1
(43) Pub. Date: May 10, 2007

(54) Real time caller information retrieval and display in dispatch calls

(75) Inventors: Ketan N. Desai, Sunrise, FL (US); Swetal A. Patel, Plantation, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/267,624

(22) Filed: Nov. 4, 2005

(51) Int. Cl. H04M 3/42; H04B 1/38

(52) U.S. Cl. 455/566; 455/415

(57) ABSTRACT

A method, wireless device and system retrieve and display caller information in real time by enabling a local data ID send feature on a calling wireless device (102), transmitting identification information (304) associated with the calling wireless device (102) and stored locally on the calling wireless device (102) to a receiving wireless device (104), receiving the identification information (304) at the receiving wireless device (104), and displaying the identification information (304) associated with the calling wireless device (102) on the receiving wireless device (104). The identification information contains a name, a phone number, and/or a direct connection ID. The local data ID send feature can be enabled for all calls initiated by the calling wireless device (102) or enabled for a single call basis.

### FIELD OF THE INVENTION

The present invention generally relates to the field of telecommunications and more specifically to a method and apparatus to retrieve and display caller information during dispatch calls on a real-time basis.

### BACKGROUND OF THE INVENTION

In today's society, communications by way of cellular phones or other mobile telecommunications devices has become routine. Users depend upon their phones to stay in contact at a moment's notice. Certain systems, such as Motorola's Integrated Digital Enhanced Networks (iDEN), provide an even faster response time by allowing users to communicate on an almost instantaneous basis through dispatch calls placed directly between units on the same system.

An important feature of these phones is the ability of the unit receiving the call to identify the person making the call. Most mobile handsets have a “Contacts ” or “Phone Book” database that enables the user to store information relating to an individual caller. For instance, a person's name and a variety of associated phone numbers, ID numbers, or email addresses are stored locally on the handset. This database serves a dual role: first, the user can easily place calls merely by accessing the desired name in the database, and second, when a call is received from a number already stored in the database, the phone displays the associated name, identifying the calling party.

However, during a dispatch call, if an incoming call does not have caller information stored in the Contacts database, there is no way for the called handset to know the calling party information such as the name of the caller. The receiving handset must display only a network supplied ID, such as an Urban Fleet Member ID (UFMI). This may result in the called party ignoring the dispatch call and thereby potentially missing important calls merely because the ID is not readily recognizable.

Therefore, a need exists to overcome the problems with the prior art, as discussed above.

### SUMMARY OF THE INVENTION

Briefly, one embodiment of the present invention provides a method, wireless device, and system for retrieving and displaying caller information, by enabling a local data ID send feature on a calling wireless device, transmitting identification information associated with the calling wireless device and stored locally on the calling wireless device to a receiving wireless device, receiving the identification information at the receiving wireless device, and displaying the received identification information associated with the calling wireless device on the receiving wireless device.

The identification information associated with the calling wireless device contains a name field, a phone number field, and a direct connect ID field. The method displays the contents of the name field on the receiving wireless device.

The local data ID send feature on the calling wireless device is enabled for all calls initiated by the calling wireless device or on a single call basis.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a dispatch call system with real time caller information retrieval and display, in accordance with one embodiment of the present invention;

FIG. 2 is a detailed block diagram depicting a wireless device of the dispatch call system of FIG. 1 according to one embodiment of the present invention;

FIG. 3 is a detailed block diagram illustrating an exemplary caller information record and minimal caller information sub-record of the system of FIG. 1, according to one embodiment of the present invention;

FIG. 4 is an operational flow diagram illustrating an operational sequence for a handset to send caller information during a dispatch call, according to an embodiment of the present invention; and

FIGS. 5 and 6 are operational flow diagrams illustrating operational sequences for a handset to receive and display caller information during a dispatch call, according to exemplary embodiments of the present invention.

### DETAILED DESCRIPTION

Terminology Overview

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application typically includes a subroutine, a function, a procedure, an object method, an object implementation, an executable application, an applet, a servlet, a source code, an object code, a shared library/dynamic load library and/or other sequence of instructions designed for execution on a computer system.

While the specification concludes with claims defining the features of the invention that are regarded as novel, it is believed that the invention will be better understood from a consideration of the following description in conjunction with the drawing figures, in which like reference numerals are carried forward.

Overview

The present invention overcomes problems with the prior art by providing necessary caller information, such as the caller name, phone number, and direct connection ID (e.g. UFMI), directly from the calling handset to the receiving handset. The called party is no longer required to have previously stored information regarding the calling party in a database on the receiving handset in order to display the identification of the calling party.

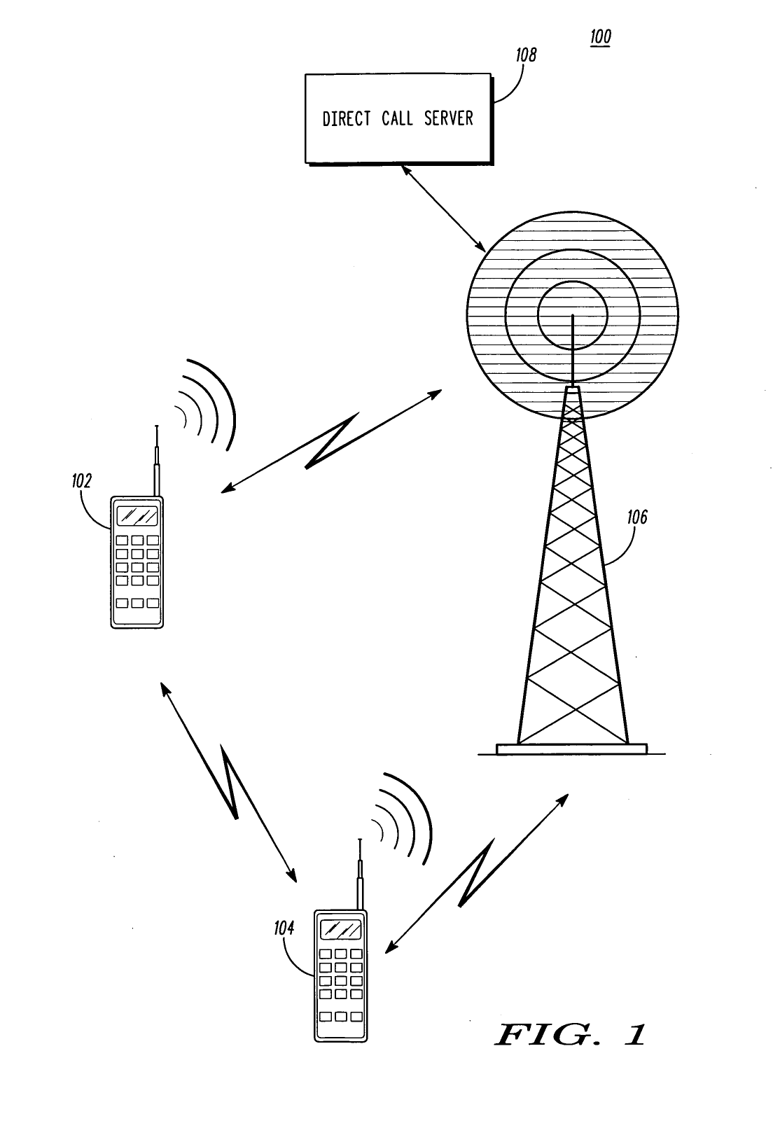

FIG. 1 illustrates a dispatch call system 100 with real time caller information retrieval and display in accordance with one embodiment of the present invention. The exemplary system includes at least two wireless mobile subscriber devices (or wireless devices) 102 and 104. Each wireless device 102 and 104 has the ability to act as either the calling handset or the receiving handset. Each wireless device 102 and 104 is operating within range of a cellular base station 106. The cellular base station 106 has the ability to communicate with other base stations and thus is able to communicate with additional wired and wireless devices (not shown). The base station 106 is also in communication with a direct call server 108 running software to facilitate the exchange of information directly between wireless handsets 102 and 104.

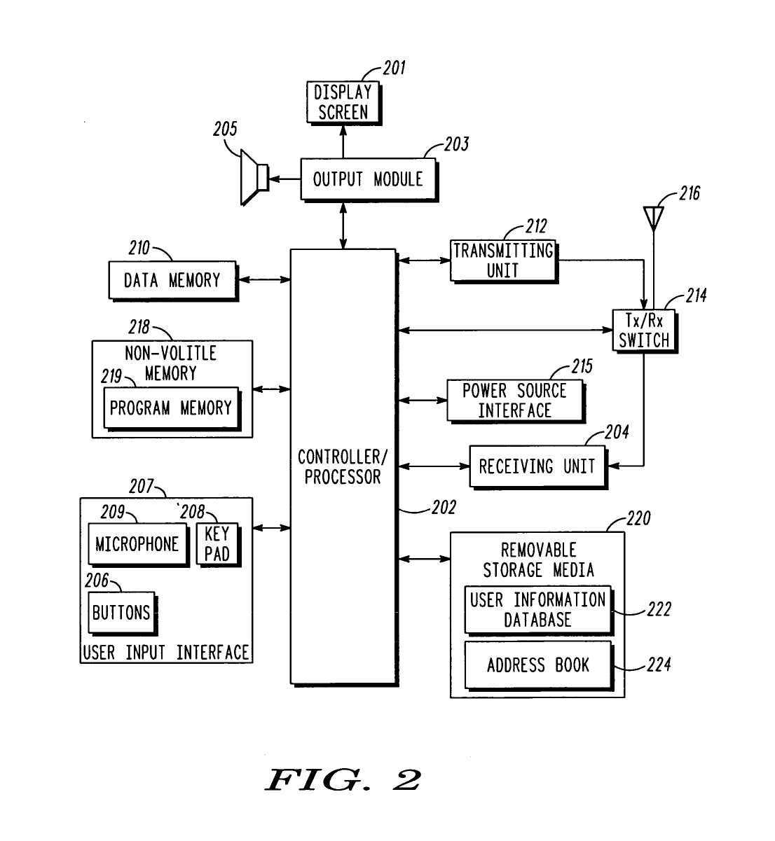

Referring to FIG. 2, a wireless device 102 and 104, in accordance with one embodiment of the present invention, is shown in more detail. Note that the terms electronic device, phone, cell phone, radio, handset, and wireless device are used interchangeably throughout this document in reference to an exemplary electronic device. The wireless device 102 and 104 of the exemplary dispatch call system 100 includes a keypad 208, other physical buttons 206, and an audio transducer, such as a microphone 209, to receive and convert audio signals to electronic audio signals for processing in the electronic device 102 in a well known manner, all of which are part of a user input interface 207. The user input interface 207 is communicatively coupled with a controller/processor 202. The electronic device 102 and 104, according to this embodiment, also comprises a data memory 210; a non-volatile memory 218 containing a program memory 219, and a power source interface 215.

The electronic device 102 and 104, according to this embodiment, transmits and receives signals for enabling a wireless communication such as for a cellular telephone, in a well known manner. For example, when the wireless communication device 102 and 104 is in a “receive” mode, the controller 202 controls a radio frequency (RF) transmit/receive switch 214 that couples an RF signal from an antenna 216 through the RF transmit/receive (TX/RX) switch 214 to an RF receiver 204, in a well known manner. The RF receiver 204 receives, converts, and demodulates the RF signal, and then provides a baseband signal to an output module 203 and a transducer 205, such as a speaker, to output received audio. In this way, for example, received audio can be provided to a user of the wireless device 102 and 104. Additionally, received textual and image data is presented to the user on a display screen 201. A receive operational sequence is normally under control of the controller 202 operating in accordance with computer instructions stored in the program memory 219, in a well-known manner.

In a “transmit” mode, the controller 202, for example responding to a detection of a user input (such as a user pressing a button or switch on the keypad 208), controls the audio circuits and couples electronic audio signals from the audio transducer 209 of a microphone interface to transmitter circuits 212. The controller 202 also controls the transmitter circuits 212 and the RF transmit/receive switch 214 to turn ON the transmitter function of the electronic device 102 and 104. The electronic audio signals are modulated onto an RF signal and coupled to the antenna 216 through the RF TX/RX switch 214 to transmit a modulated RF signal into the wireless direct call communication system 100. This transmit operation enables the user of the device 102 and 104 to transmit, for example, audio communication into the wireless direct call communication system 100 in a well known manner. The controller 202 operates the RF transmitter 212, RF receiver 204, the RF TX/RX switch 214, and the associated audio circuits according to computer instructions stored in the program memory 219.

Additionally, the wireless handset device 102 and 104 includes a removable storage media 220 which stores a user information database 222 containing personal and system information about the owner/user of the handset 102 and 104, as well as an address book 224 (i.e. “Contacts” database), generally created by the user, containing personal information, such as names, addresses, and phone numbers, for those people with whom the user wishes to communicate. The removable storage media 220 also functions under the command of the controller/processor 202.

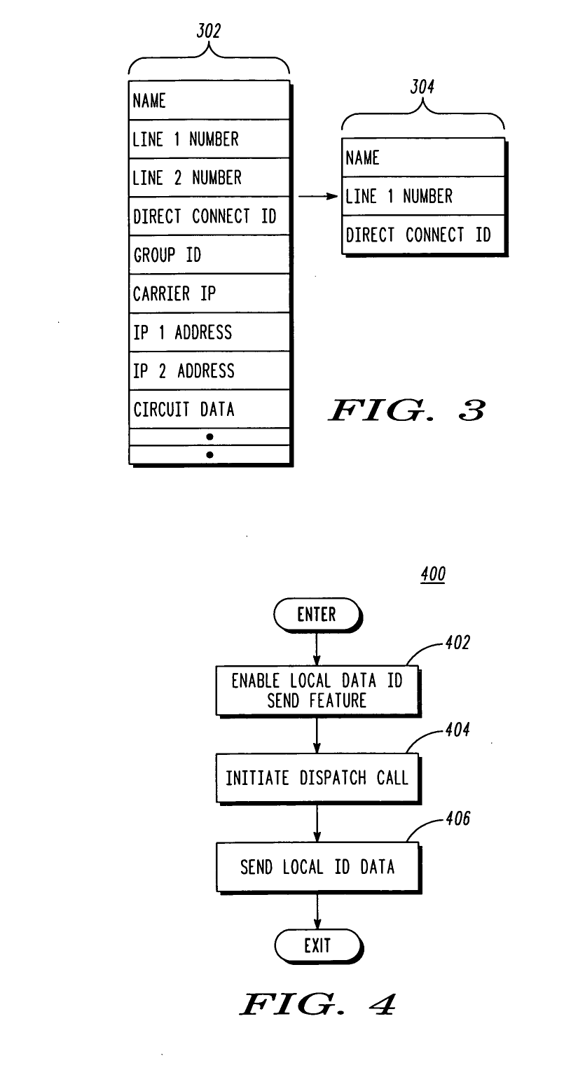

FIG. 3 depicts an exemplary user record 302 stored in the user information database 222. The user record 302 contains information pertinent to the owner/user of that particular handset 102 and 104, including such fields as “Name,” “Line 1 number,” “Line 2 number,” “Direct Connect ID” (or UFMI), “Group ID,” “Carrier IP,” “IP 1 address,” “IP 2 address,” “Circuit data,” etc. An embodiment of the present invention uses a smaller local ID data subset 304 of this user record 302 to enable a receiving handset 104 to identify the name of the caller initiating a dispatch call. The local ID data 304 contains, at a minimum, the user's name, Line 1 phone number, and Direct Connect ID (i.e. UFMI). This information is transferred over the voice network in a manner taught by United States Patent Application Publication No. US 2004/0220803 A1, “Method and Apparatus for Transferring Data over a Voice Channel,” published Nov. 4, 2004, and United States Patent Application Publication No. US 2005/0096071 A1, “Simultaneous Voice and Data Communication over a Wireless Network,” published May 5, 2005,the entire teachings of which are hereby incorporated by reference.

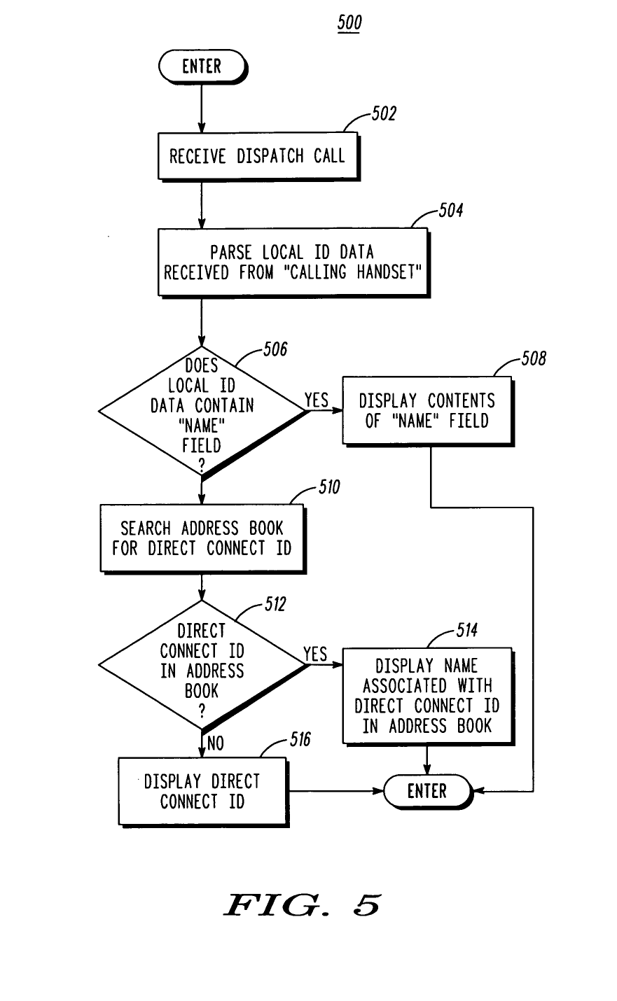

Turning now to FIG. 4, a calling handset 102 enters the method, at step 402, by enabling a local data ID send feature. This feature may be implemented by providing a simple Dispatch setting option in the user settings. The local data ID send feature can be activated for all dispatch calls or only for a specific call. Next, the calling handset 102 initiates a dispatch call to a receiving handset 104, at step 404. Once a successful dispatch session has been established, the calling handset 102 sends the local ID data 304 to the receiving handset 104.

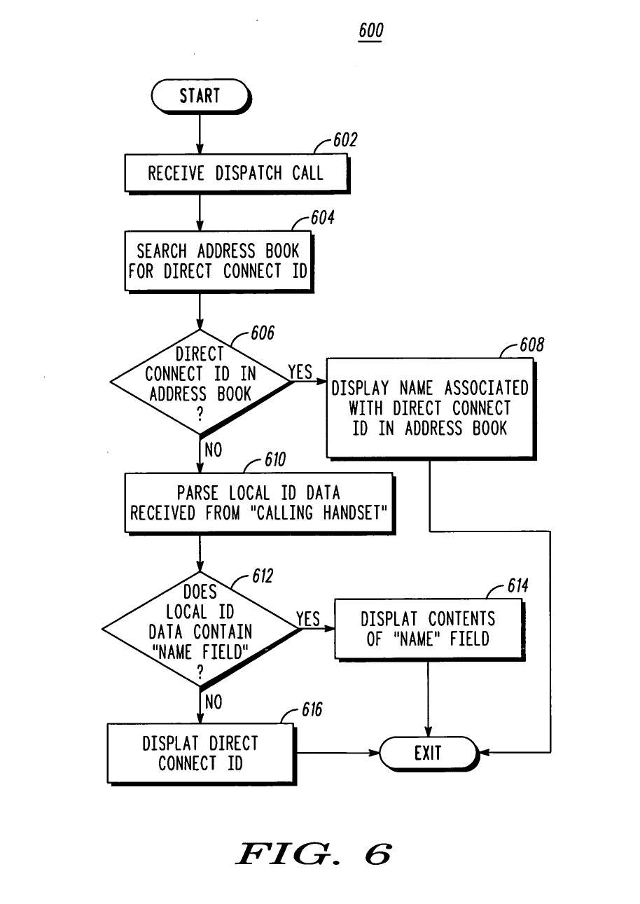

FIG. 5 illustrates an exemplary embodiment of a method with the receiving handset 104 according to the present invention. The method begins, at step 502, when the receiving handset 104 receives a dispatch call that includes local ID data 304. The local ID data 304 received from the calling handset 102 is parsed, at step 504. Next, at step 506, the method checks the local ID data 304 for a “Name” field. If the local ID data 304 includes a “Name” field containing caller information, the method displays the contents of the “Name” field to the user of the receiving handset 104, at step 508, and then the method ends. The caller information from the “Name” field is displayed to the user. However, if the local ID data 304 does not include a “Name” field or alternatively if it does include a “Name” field but the contents are empty or NULL, then the method searches the address book 224 for the network supplied Direct Connect ID, at step 510. If the received Direct Connect ID is contained in the address book 224, at step 512, the method displays the name associated with the Direct Connect ID as entered in the address book 224, at step 514. If the Direct Connect ID is not contained in the address book 224, the method displays only the Direct Connect ID, at step 516.

An operational sequence, according to an alternative embodiment, is illustrated in FIG. 6. The method begins, at step 602, when the receiving handset 104 receives a dispatch call that includes local ID data 304. Next, the receiving handset 104 searches its local address book 224, at step 604, to see if the network supplied Direct Connect ID is associated with an entry in the local address book 224. If the received Direct Connect ID is contained in the address book 224, at step 606, the method displays the name associated with the Direct Connect ID as entered in the address book 224, at step 608, and the method ends. If the Direct Connect ID is not contained in the address book 224, then the local ID data 304 received from the calling handset 102 is parsed, at step 610. Next, at step 612, the method checks the local ID data 304 for a “Name” field. If the local ID data 304 includes a “Name” field containing caller information, the method displays the contents of the “Name” field to the user of the receiving handset 104, at step 614, and the method ends. However, if local ID data 304 does not include a “Name” field or alternatively if it does include a “Name” field but the contents are empty or NULL, then the method displays only the Direct Connect ID, at step 616.

In another alternative embodiment, the calling wireless device 102 automatically sends the local ID data 304 with every Dispatch Call that does not have the Called (Target) Party information stored locally in the calling wireless device, such as in a local address book of the calling wireless device. The calling wireless device 102 determines, in this case, that if the target wireless device identifying information is not found stored locally, such as in its own local address book, then it is less likely that calling wireless device identifying information will be stored in the target wireless device, such as by having caller identification information stored in a local address book of the called wireless device.

According to an embodiment, the calling wireless device 102 requests permission from the user of the calling wireless device 102 to send the local ID data 304 including caller identifying information. That is, the calling wireless device 102 requests permission from the user of the calling wireless device 102 to send identification information, such as to identify the calling wireless device 102 or a user thereof or both, to a user of a receiving wireless device 104. This feature allows the caller to maintain privacy. Permission is granted by the user of the calling wireless device 102, at the user's discretion, on a per single call basis to allow the user to choose when to send the local ID data 304 including the caller identifying information.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention solves problems with the prior art, such as by providing the calling party's name, or other identifying information, to be displayed to the called party even though this information is not stored in the “Contacts” (i.e., in the phone book or address book) of the called party. The called party has a better option to ignore or reply to the dispatch call based upon the name received with the call. This allows the user to make a more informed decision about answering or preparing for the call.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows a computer to read data, instructions, messages or message packets, and other computer readable information. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method for retrieving and displaying caller information in a dispatch call, the method comprising:
enabling a local ID data send operation of a calling wireless device, the local ID data including identification information identifying the calling wireless device to a user of a receiving wireless device; and
transmitting the local ID data from the calling wireless device, the identification information included in the local ID data having been stored locally on the calling wireless device, and wherein the transmitted local ID data being destined for reception by a receiving wireless device, and further wherein the received identification information being displayable by the receiving wireless device thereby identifying the calling wireless device to a user of the receiving wireless device.

2. The method of claim 1, wherein the identification information associated with the calling wireless device comprises any one or a combination of a name field, a phone number field, or a direct connection ID.

3. The method of claim 2, further comprising displaying the contents of the name field with the receiving wireless device.

4. The method of claim 1, wherein the local data ID send operation on a calling wireless device being enabled for all calls initiated by the calling wireless device.

5. The method of claim 1, wherein the local data ID send operation on a calling wireless device being enabled on a per single call basis.

6. The method of claim 1, further comprising:
requesting permission from the user of the calling wireless device to send the identification information identifying the calling wireless device to a user of a receiving wireless device.

7. The method of claim 1, further comprising:
searching a local address book of the calling wireless device for an entry associated with identification information of the receiving wireless device; and
in response to finding no such entry, transmitting local ID data from the calling wireless device, the transmitted local ID data including identification information associated with the calling wireless device and destined for reception by the receiving wireless device, the transmitted identification information having been stored locally on the calling wireless device.

8. A wireless device for retrieving and displaying caller information, the wireless device comprising:
a controller for enabling a local ID data send operation of a calling wireless device, the local ID data including identification information identifying the calling wireless device to a user of a receiving wireless device; and
a transmitter, communicatively coupled with the controller, for transmitting the local ID data from the calling wireless device, the identification information included in the local ID data having been stored locally on the calling wireless device, and wherein the transmitted local ID data being destined for reception by a receiving wireless device, and further wherein the identification information being displayable by the receiving wireless device thereby identifying the calling wireless device to a user of the receiving wireless device.

9. The wireless device of claim 8, wherein the identification information associated with the calling wireless device comprises any one or a combination of a name field, a phone number field, or a direct connection ID.

10. The wireless device of claim 8, further comprising:
a receiver, communicatively coupled with the controller, for receiving identification information associated with a separate calling wireless device, the identification information having been stored locally on the separate calling wireless device; and
a display, communicatively coupled with the controller, for displaying the received identification information associated with the separate calling wireless device.

11. The wireless device of claim 10, wherein the display, communicatively coupled with the controller, further for displaying the contents of a name field of a received identification information associated with the separate calling wireless device.

12. The wireless device of claim 8, wherein the local data ID send operation is enabled for all calls initiated by the wireless device.

13. The wireless device of claim 8, wherein the local data ID send operation is enabled on a per single call basis.

14. The wireless device of claim 8, wherein the controller further for requesting permission from the user of the wireless device to send the identification information identifying the calling wireless device to a user of a receiving wireless device.

15. The wireless device of claim 8, further comprising:
a memory including a local address book wherein the controller, communicatively coupled with the memory, for searching the local address book of the calling wireless device for an entry associated with identification information of the receiving wireless device; and
the controller, responsive to the searching of the local address book finding no such entry, for transmitting local ID data from the calling wireless device, the transmitted local ID data including identification information associated with the calling wireless device and destined for reception by the receiving wireless device, the transmitted identification information having been stored locally on the calling wireless device.

16. A direct call communication system comprising:
at least one calling wireless device, each such calling wireless device comprising:
a controller for enabling a local ID data send operation of the calling wireless device, the local ID data including identification information identifying the calling wireless device to a user of a receiving wireless device; and
a transmitter, communicatively coupled with the controller, for transmitting the local ID data from the calling wireless device, the identification information included in the local ID data having been stored locally on the calling wireless device, and wherein the transmitted local ID data being destined for reception by a receiving wireless device, and further wherein the identification information being displayable by the receiving wireless device thereby identifying the calling wireless device to a user of the receiving wireless device; and
at least one receiving wireless device, each such receiving wireless device comprising:
a controller;
a receiver, communicatively coupled with the controller, for receiving identification information associated with a calling wireless device, the identification information having been stored locally on the calling wireless device; and
a display, communicatively coupled with the controller, for displaying the received identification information associated with the calling wireless device.

17. The system of claim 16, wherein the local data ID send operation is enabled for all calls initiated by the calling wireless device.

18. The system device of claim 16, wherein the local data ID send operation is enabled on a per single call basis.

19. The system of claim 16, wherein the controller of the calling wireless device further for requesting permission from the user of the calling wireless device to send the identification information identifying the calling wireless device to a user of a receiving wireless device.

20. The system of claim 16, wherein the calling wireless device comprises:
a memory including a local address book wherein the controller of the calling wireless device, communicatively coupled with the memory, for searching the local address book of the calling wireless device for an entry associated with identification information of the receiving wireless device; and
the controller of the calling wireless device, responsive to the searching of the local address book finding no such entry, for transmitting local ID data from the calling wireless device, the transmitted local ID data including identification information associated with the calling wireless device and destined for reception by the receiving wireless device, the transmitted identification information having been stored locally on the calling wireless device.
